(19) United States
(12) Patent Application Publication
(10) Pub. No.: US 2007/0124202 A1
(43) Pub. Date: May 31, 2007

(54) Systems and methods for collecting data and measuring user behavior when viewing online content

(75) Inventor: Geoff Simons, Seattle, WA (US)

Correspondence Address: Rupak Nag, 4406 Oakland Ave., Minneapolis, MN, 55407, US

(73) Assignee: Chintano, Inc.

(21) Appl. No.: 11/290,149

(22) Filed: Nov. 30, 2005

(51) Int. Cl. G06Q 30/00

(52) U.S. Cl. 705/14

(57) ABSTRACT

Methods and systems are described for a method that enables the examining of user behavior while viewing content on the Internet. The collection and analysis of user behavior heuristics can be very useful in determining a user's interests and can be used in delivering more targeted ads to the user. JavaScript is embedded in an ad that is delivered to a Web site that a user is visiting. The JavaScript is used to collect data on how the user is behaving on the Web site. It measures heuristics such as “blur” and “focus” which provide a detailed analysis of a user's viewing habits. These heuristics can indicate how often a user scrolls through content, minimizes/maximizes windows, flips among various applications (e.g. e-mail, reading content, instant messaging, etc.) among numerous other user actions. By examining these habits and other behavior, it is possible to gain more insight into what type of content a user is interested in. By using these data, an ad server or other ad-related system can select ads that are more targeted at the interests of the user.

### BACKGROUND OF THE INVENTION

1. Field of the Invention

The present invention relates generally to multilingual online advertising. More specifically, it relates to computer software for contextual ad targeting in multiple languages.

2. Introduction

The field of advertising on Web sites on the Internet has been growing steadily since the inception of the Internet. The types of ads and the technology for targeting and delivering them to Web sites has also grown increasingly sophisticated.

One of the more recent advancements is referred to as contextual ad targeting. As those in the advertising field know, in this form of advertising one or more topics of a Web site page—the context of the page—are determined and are used typically as one component in selecting an ad to be delivered to that page. In other words, an ad is delivered to a page based partly or wholly on the content on that page with the presumption that the viewer will be more likely to view the ad because it relates to content that the viewer is interested in. This has been a prevalent and effective advertising trend.

It is generally accepted that serving ads based on real-time contextual ad targeting is more effective than serving ads without regard to context, that is, randomly or blindly. Most advertisers would prefer that their ads be seen by consumers for whom it has been determined are presumptively interested in the advertiser's goods or services. And Web sites that have advertisements would prefer displaying contextually targeted ads in real time because they can charge a higher rate for displaying the ad.

Presently, the utility of data and statistics indicating the effectiveness of online ads and ad-viewing behavior is limited. These data and statistics can be useful in determining a user's interests and, thus, in delivering online contextually targeted ads. Examples of these data include: whether or not an ad was clicked on a given impression, the URL of the page to which the ad was served, times of day when the ad was shown, user cookie, and IP address which allows for possible geographic-based targeting. These types of data have been used for years in the online and industry, however their usefulness is reaching capacity. For example, although these data provide a static picture of a user's interaction with a Web page, they do not tell the advertiser or the ad network how the user is behaving at a Web page; that is, what a user is really doing at the page and what the user is looking at. This type of user behavior event capturing can be very useful in measuring the effectiveness of ads and in delivering more targeted, contextual ads. JavaScript is presently used to perform traditional tracking and data gathering of the type described above. Presently, an ad network or ad server system is generally limited to merely a history of impressions for a given user.

Thus, what is needed are processes and systems that examine and collect data on user behavior and actions using a non-intrusive data collection means, preferably one that is presently being used but can be further utilized to collect data relating to user viewing behavior.

### SUMMARY OF THE INVENTION

One aspect of the present invention is a method that enables the examining of user behavior while viewing content on the Internet. The collection and analysis of user behavior heuristics can be very useful in determining a user's interests and can be used in delivering more targeted ads to the user. In one embodiment, JavaScript is embedded in an ad that is delivered to a Web site that a user is visiting. The JavaScript is used to collect data on how the user is behaving on the Web site. It measures heuristics such as “blur” and “focus” which provide a detailed analysis of a user's viewing habits. These heuristics can indicate how often a user scrolls through content, minimizes/maximizes windows, flips among various applications (e.g. e-mail, reading content, instant messaging, etc.) among numerous other user actions. By examining these habits and other behavior, it is possible to gain more insight into what type of content a user is interested in. By using these data, an ad server or other ad-related system can select ads that are more targeted at the interests of the user.

Additional features and advantages of the invention will be set forth in the description which follows, and in part will be obvious from the description, or may be learned by practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth herein.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a diagram of the components and data flow of the overall process of delivering contextual ads in a source language in accordance with one embodiment of the present invention.

FIG. 2 is a flow diagram of a process for classifying content in a source language using modules and components in a native language, such as English, in accordance with one embodiment of the present invention.

FIG. 3 is a block diagram showing a classifier server effectively having two classifiers: a primary classifier based on a large-scale English training set and a supplemental or secondary classifier 306 based on a training set in the source language.

FIGS. 4A to 4C are graphs illustrating relationships between topics and relevancy derived from the use of various classifiers and the combination of classification methods.

FIG. 5 is a time sequence diagram of a process of examining user behavior while viewing content on the Internet in accordance with one embodiment of the present invention.

### DETAILED DESCRIPTION OF THE INVENTION

Various embodiments of the invention are discussed in detail below. While specific implementations are discussed, it should be understood that this is done for illustration purposes only. A person skilled in the relevant art will recognize that other components and configurations may be used without parting from the spirit and scope of the invention.

Methods and systems for targeting and delivering contextual ads in real time to a Web site in multiple languages is described in the various figures. The present invention is a software application implemented over a computer network, specifically the Internet, using server and client computers utilizing Web browsers. The software application enables the delivery of targeted contextual ads in a non-English source language to be displayed on a source language Web site. Contextual ad serving is becoming more accurate and common on English Web sites. The application of the present invention leverages existing English language classifiers and training sets, and sophisticated translation services and software to implement contextual ad serving for Web sites that are not in English. More specifically, the present invention is for Web sites that are in languages that do not have large training sets or accurate classifiers (described below) and are viewed in countries that presently may not have the necessary technology or equipment for real-time, online contextual ad serving.

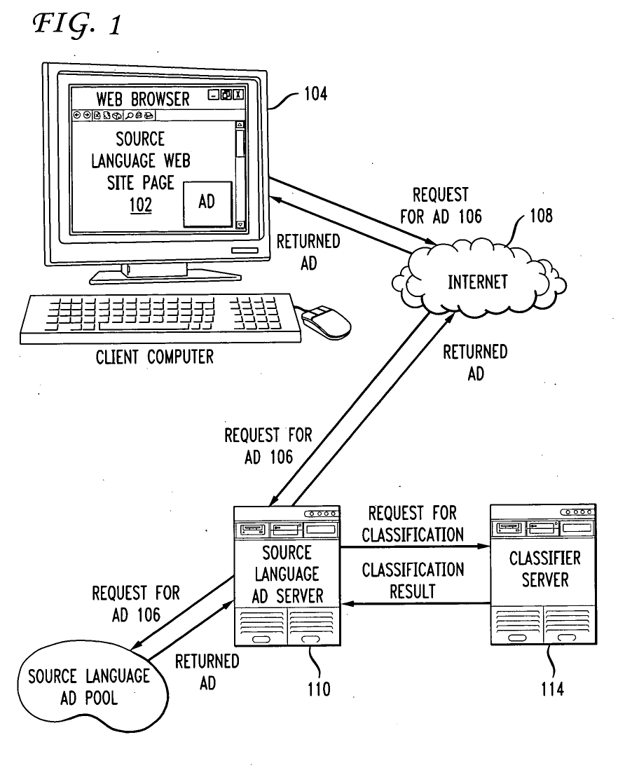

FIG. 1 is a diagram of the components and data flow of the overall process of delivering contextual ads in a source language in accordance with one embodiment of the present invention. A Web site page 102 is displayed via a Web browser on a client computer 104. Page 102 has content that relates mostly to topic A and to a lesser degree topic B. The content on Web page 102 is in a non-English source language and client computer 104 operates in a region or country where online real-time contextual ad serving technology using source language components has not been implemented. Web site page 102 displays ads in the source language and therefore presently sends requests to ad servers in an ad serving network, but the ads, without use of the present invention, are static or non-contextual.

A request 106 for an ad is transmitted from page 102 on client computer 104 over the Internet 108 to an ad server 110. An ad server is a computer that manages the retrieval and transmission of ads between Web sites and pools of ads. Ad server 110 in the described embodiment of the present invention manages ads that are in the source language and can be referred to as a source language ad server. Typically, ad request 106 is a URL of the Web site page and is in a format known to those of ordinary skill in the field of online ad serving technology. The URL or other form of the request is in the source language.

Upon receiving ad request 106 via the Internet 108, ad server 110 begins the process of retrieving an appropriate ad for page 102. In the described embodiment of the present invention, an appropriate ad is an advertisement that takes into account the context of the content on Web page 102, that is, an ad that is related or targeted to topic A or topic B. In another embodiment the appropriate ad takes into account the content of page 102 as well as geographical, temporal, and other factors known to those skilled in the art. In another embodiment the appropriate ad is based solely on the context of page 102.

In the described embodiment, before retrieving a source language ad from ad pool 112, ad server 110 utilizes the services of a classifier server 114. In the described embodiment, ad server 110 transmits the URL of Web site page 102 to classifier server 114. In another embodiment, the actual content of page 102 is transmitted to server 114. Classifier server 114 receives the source language URL of Web site page 102 or its actual content. In the present invention, classifier server 114 returns a classification result 116 in the source language to ad server 110. The classification process is described in further detail below.

In the described embodiment, classification result 116 consists of one or more topics. This single topic or list of topics 116 is transmitted to ad server 110 in the source language. In another embodiment, each topic is paired with a numerical value, such as a percentage, that indicates the weight of the topic. This weight reflects the likelihood that content on Web site page 102 is related to the topic that is paired with the weight.

Ad server 110 uses source language classification result 116 to retrieve a source language ad from its ad pool. As is known to those skilled in the field of online ad serving technology, an ad pool is typically organized similar to a tree structure to reflect a series of categories, wherein each category is divided further into a series of topics, sub-topics, and so on. Using classification result 116, ad server 110 can retrieve the appropriate ad from the ad pool and can, as mentioned above, use other geographic and temporal factors. Once the appropriate ad is retrieved, ad server 110 transmits the ad back to client computer 104 so it can be displayed via a browser in Web site page 102. The person viewing the Web site page will then see an ad that relates to the content she is viewing on the page, thus presumably making the ad more effective.

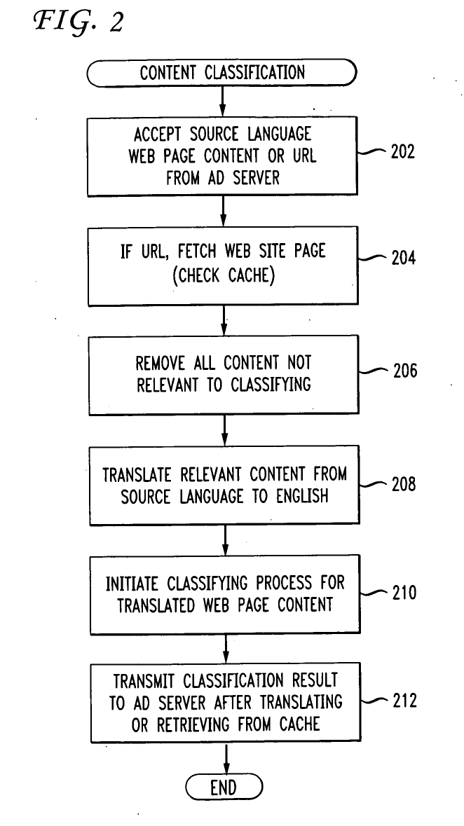

FIG. 2 is a flow diagram of a process for classifying content in a source language using modules and components in a native language, such as English, in accordance with one embodiment of the present invention. As described in FIG. 1, source language ad server 110 does not have the capability to classify content from Web site page 102. Thus, this function is completed by classifier server 114. In the described embodiment, a process of classifying source language content is performed by or is under the control of classifier server 114. In the described embodiment, classifier server 114 is operated by a third-party service provider, such as Chintano, Inc. of Seattle, Wash. The service provider is responsible for accepting source language input, for example a block of text, from an ad server and returning to the ad server a classification result in the source language. In the described embodiment, the service provider performs all the classification functions for the non-English source language ad server, which is typically owned by an ad network company in the source language country or region.

Starting with step 202 of FIG. 2, classifier server 114 accepts input from ad server 110 or any other component requesting a classification result for the purpose of serving contextual online ads. In a typical scenario the input is a source language URL for Web site page 102. The input can also be source language text or an entire Web site page. At step 206 classifier server 114 fetches Web site page 102. This step is not necessary if the page is delivered in step 202. If the input is a URL, server 114 fetches the page. In one embodiment, server 114 checks to see if the page corresponding to the URL has been cached by server 114. Normally the content of Web site page 102 is formatted and structured using HTML. The content may also be formatted using another type of mark-up language that is compatible with the Internet.

Once classifier server 114 has identified and has possession of the content of Web page 102, at step 204 server 116 removes all content not relevant to the purpose of classifying Web page 102. Typically, this non-relevant content consists mainly of HTML. Methods of parsing or removing HTML code from a Web page are well known in the field of Internet application programming. In the described embodiment, content that may be relevant, such as graphics, pictures, animation, and so on, is also removed or stripped from the page. In other embodiments, if the technology is available, non-text content may be kept in with the relevant textual content of the page. Certain content, such as attribute values, associated with specific HTML tags may also be removed, such as keywords that the creator of Web page 102 inserted so that the page is more likely, for example, to appear in query results from Internet search engines. It is possible that these keywords, when examined with the normal content or ‘payload’ of a Web page, may adversely skew or bias the determination of the real context of the Web page. Whether these keywords or other values should remain in the text or be removed before the substantive classification process begins will be decided by designers of the multilingual contextual ad serving system of the present invention at the time the system is being created and implemented. Other attributes in HTML may be removed or included depending on how the designers of the system of the present invention believe they will effect the classification.

At step 208 of FIG. 2 the relevant text of Web page 102 is translated from the source language to English, the native language in the described embodiment. In the described embodiment, translation from the source language to English is performed by an external translation service that is called by classifier server 114. In another embodiment, classifier server 114 invokes translation software to perform the task. In either case, the translating service or module requires knowledge of the character set of the source language. The most prevalent character set is Unicode for many Western languages and GB2313 (?) for Chinese. Knowledge of the character set enables the translation process or service to parse the characters in the block of source language relevant text. With respect to removing the HTML, most character sets have ASCII as a base thus facilitating the removal of HTML by classifier server 114. The translation service or process accepts as input the source language text with all normal spacing and punctuation in tact. There are numerous qualified translation services and sophisticated translation software programs that can be used. In the described embodiment, a third-party translation service is used to translate text.

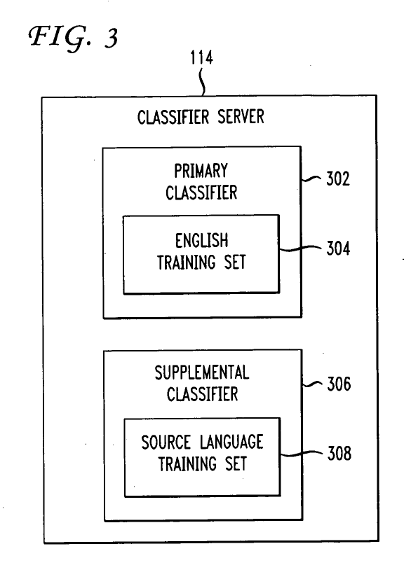

At step 210 classifier server 114 receives content of Web page 102 in English from the translation service or module. At this stage server 114 initiates a process of classifying the content. This process is described in more detail in FIG. 3. The classification process produces a classification result which, in the described embodiment, is comprised of one or more topics paired with weights, such as a percentage, for example, “Topic A′, 0.73; Topic B′, 0.11, Topic C′, 0.9, Topic D′, 0.7” or “Topic A′, 0.99, Topic B′, 0.01”. The format of the classification result can vary without affecting the overall result or functionality of the present invention. The weights may be expressed in a different format or may not be included at all. The breadth of the topics can also vary significantly—they can be broad when using a classification system with only 30 topics or far more granular when using a classification system with 30,000 topics. It is also possible that a classification result always consists of no more than one topic and has no associated weight.

At step 212, the classification result in the source language is transmitted to the ad server. In the described embodiment the translated classification result is retrieved from a cache by the classifier rather than being translated repeatedly by a translation service or module. Having classifier server 114 use a table it has in cache memory which pairs English terms (each term being a topic name) with source language translations of each term to retrieve the translated (i.e., source language) version of a classification result, whether using the 30 topic or 30,000 topic classification system, is likely to be more efficient than repeatedly translating. However, in another embodiment, the classification result can be sent to the translation service or translation program and translated. In the described embodiment, the numerical weight values are removed and the topic names alone are converted to the source language using the cache or translation. In another embodiment, the numerical weight values and the topic names are translated.

In another preferred embodiment, classifier server 114 effectively has two classifiers as shown in FIG. 3. One is a primary classifier 302 based on a large-scale English training set 304, and a supplemental or secondary classifier 306 based on a training set in the source language 308.

A training set is comprised of a set of documents divided into smaller sets of documents that describe the topics of interest. When a subject document is classified by the classification server, it compares the text of that document against the text contained in all the documents in each topic to determine the weight or relevance of that topic in the subject document. The source language training set will typically be much smaller than the primary English training set and will grow iteratively.

A two-tier classifier system embodied in classifier server 114 can lead to more accurate classification of the submitted text which, in turn, may result in retrieval of more accurate contextual ads. The supplemental classifier 306, based on source language training sets 308 translates or evaluates words or phrases that were left untranslated by primary classifier 302. As described above, translation services and software programs have become advanced over the last couple of decades. However, there will be cases where certain words are returned untranslated or cannot be translated accurately, such as names of people, geographic locations, terms of art, argot, new phrases and terms (e.g., pop and slang expressions), concepts, idioms, colloquialisms, and so on. Such words and phrases can have a direct bearing on the context of the content of a Web site page and if considered in the classification of that content will produce more accurate classification results.

In the two-tier classification system embodiment, the classification system receives as input the translated text and the untranslated words and phrases. The translated text is passed to the primary classifier as described above. The untranslated words are given to the appropriate supplemental classifier for that source language, which can be determined from the country extension in the URL. There can be as many supplemental classifiers as there are source languages that can be processed by the classification system of the present invention.

Supplemental classifier 306 has initially a source language supplemental vocabulary training set 308 that is specialized to evaluate the untranslated words and determine what it believes the context is, based solely on the untranslated words. It produces a classification result which can include only a topic or a topic and a weight, depending on the sophistication of the supplemental classifier. By its nature, this aspect of the classification process looks at new, unusual, or untranslatable words and phrases and provides a classification that essentially takes into account a current cultural or source-language speaker's point of view of what the Web site page is about.

This is a particularly useful feature in the field of real time, targeted online advertising. In the process, supplemental classifier 306 can build its training set 308 by adding any untranslated words that were not in the initial English training set 304 or were not encountered previously. In this manner, supplemental classifier 306 iteratively builds its own training set 308 over time. At the final stage, the classification results of the primary and supplemental classifiers are combined to produce a final classification result 116. Before they are combined, classification server 114 may consider whether the supplemental classification results from supplemental classifier 306 are likely to effect the primary classification results in an adverse manner, such as in a way that is illogical or nonsensical.

Although the present invention does not claim a specific new method or algorithm for classification, the invention does involve the application of known classification methods in unique ways that make classification results that are delivered to ad server 110 more useful and beneficial for contextual online ad serving. Before this novel application and the motivations for it are described, it would be helpful to briefly discuss the properties of a few known classifiers.

Generally, a classifier takes a block of machine-readable text and analyzes it to determine what topic or topics are discussed in the text. Typically, mathematical concepts, algorithms, and theories are employed in implementing a classification analysis. Common steps taken in preparing the machine-readable text for classification using a specific classification method include tokenizing, filtering, and stemming the text by removing so-called “stop words” such as articles (“the”, “a”, etc.). These steps are known to those of ordinary skill in the field of text classifiers.

A classifier has a schema of topics and each topic has a set of terms or tokens that collectively represent the topic. The terms are derived from a training set. A training set is comprised of a set of documents divided into smaller sets of documents that describe the topics of interest. When a document is classified by the classification server, it compares the text of that document against the text in all the documents in each topic to determine the weight or relevance of that topic. Thus, a training set is typically a large volume of documents and text that covers the topic or is at least representative of the topic and can be used to identify terms most relevant to the topic.

Classifying is inherently a subjective process. The accuracy of classifiers is tested using a training set and performing what is referred to as an n-fold cross validation. For example, certain documents are omitted from the training set and the training set is rebuilt. The reconstructed training set and the original training set are then compared.

One method of classifying text that has gained acceptance derives from a probability function based on Bayes theorem and is referred to as the Bayesian method of classification. It is generally accepted in the field that the Bayesian method for classification is very effective and accurate in determining the most relevant topic of a block of text. Thus, if a Web page clearly has one dominant topic, a Bayesian classifier will return that topic and assign it a weight indicating that it is essentially the only topic for that page. For example, a first topic may be accorded a weight of 0.98 and the weight for second and third topics may be 0.015 and 0.005.

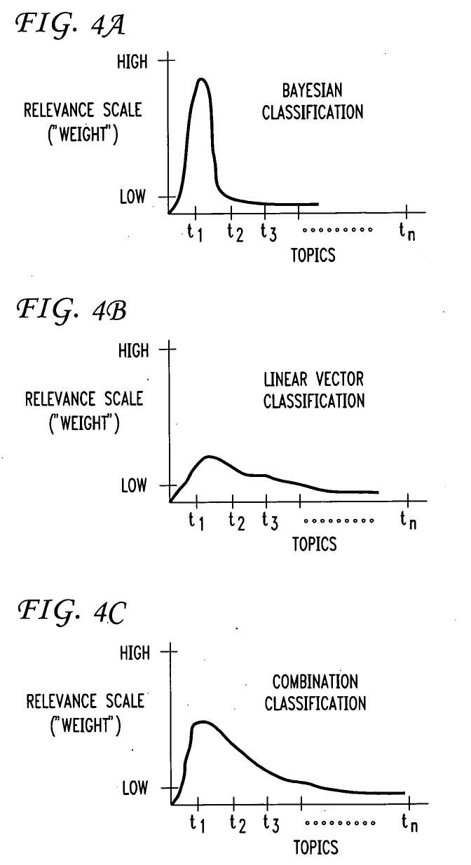

As shown in FIG. 4A, one of the drawbacks of the Bayesian method is this “over fittedness” or predominance given to the first topic, essentially dismissing the relevance of secondary topics. The x-axis maps the topics in a document and the y-axis shows the relevancy of each topic. This can be a performance concern when a block of text representing a Web page has a number of topics that would be considered relevant to an ad server. To illustrate this, suppose average viewers of a Web page (containing only text) are queried as to what topics are discussed on the Web page and the results were there are there are three topics A, B, and C: topic A is 60% relevant, topic B is 30% relevant, and topic C, 10% relevant. If the same text or page was run through a Bayesian classifier, the classification result will likely be uneven. Topic A would likely be assigned a weight of 95% and topics B and C the remaining 5%. This over-fitted or skewed result is not optimal when implementing real-time, targeted, contextual ad serving. It is preferable that an ad server be given a more accurate or normal reading of the relevancy of secondary topics. With a weight reading of 95% (topic A)-5% (all other topics), the ad server essentially has no choice but to serve an ad relating to topic A. With a ‘60-30-10’ weight reading, the ad server has more options. For instance, geographic and temporal factors that the ad server also considers may fit much better with topic B rather than with topic A. With a normal-fitted or more accurate weight reading, an ad sever can justifiably override topic A's 60% weight assignment and deliver an ad relevant to topic B.

It is hard to adjust or modify the Bayesian method alone or somehow internally adjust its results so that the first topic is not given too much and thereby diminishing the relevancy of secondary topics. That is, it is difficult or impractical to eliminate the first topic spike using solely the Bayesian method of classifying.

The goal for the classification result in its role as input to a real-time, targeted contextual ad serving system, is to have accurate rankings of topics and a fitted, non-skewed assignment of weight for each topic. One way of alleviating the Bayesian method issue of the first topic nearly always having a dominant weight is to combine the Bayesian method with other classifying methods.

Another classification method is based on a linear vector model. This method accords more evenly distributed weights for secondary topics. This is shown in FIG. 4B where a more even slope indicates a better distribution of weights. In the linear vector model a set is a vector in an n-dimensional space and each token is a dimension in an n-dimensional space.

In the described embodiment of the present invention, an approach of combining two or more classification methods is used to more evenly and accurately distribute the weights of topics in the classification result that is delivered to an ad server. Given that one of the strengths of the Bayesian method is its ability to clearly identify the most relevant topic in a block of text, its ranking of the most relevant topic is not changed in the classification result of the combination approach of the described embodiment. However, the weight of the highest ranking topic will likely be modified (lowered) and the weights of the secondary topics are raised. This is a result of combining the topic weights from the Bayesian method with topic weights from other classification methods, such as the linear vector method. This combining may involve a simple averaging of the weights or a more complex calculation.

The rankings of secondary topics are taken from the results of the linear vector classification or other non-Bayesian classification methods (which may be the same as the secondary topic rankings from the Bayesian classification). As shown in FIG. 4C, a graphical depiction of a combination of Bayesian classification results and linear vector results shows a more gradual downward slope indicating a more realistic view of the relevancy of topics in a block of text.

It is important to note that it is entirely possible that a Web page is in fact dominated by one topic and a 0.98 weight assignment is accurate and justified. In these cases, the combination approach of the described embodiment may have results very similar to those of the Bayesian approach when used alone, and the ad server should not be given a “choice” among topics. However, for pages that have many topics, such as in news sites and home pages, the combination approach may produce results more useful for real-time, contextual ad serving.

Other classification methods can be used to average the results from Bayesian classification, such as support vector kernels. In another embodiment three or more classification systems can be used to more evenly distribute the weights of the topics. Generally, other classification methods are not as accurate at determining the most relevant topic as is the Bayesian classification method but they are more suitable for evenly distributing the weights of the secondary topics (second, third, fourth relevant topics). There are also methods known in the field of text classifiers which can be used that allow obtaining an average using one classification method rather than averaging the results from combining two or more classification methods. These methods are known to those of ordinary skill in the field of text classifiers.

When an appropriate targeted, contextual ad is delivered to a Web site, a method of the present invention involves embedding JavaScript in the delivered ad as a more sophisticated feedback system for advertisers. As described in detail below, the data gathered from measuring user behavior heuristics using JavaScript can be used by advertisers or ad networks to deliver more effective ads online. Although the embedded JavaScript method of the present invention can be used with contextual ads delivered in a multilingual environment, as described above, it can also be used with English contextual and non-contextual ads. In essence, the embedded JavaScript method of measuring user behavior of the present invention can be used with any type of ad delivered online in any language, whether contextual or non-contextual or targeted or non-targeted.

In a described embodiment, JavaScript enables an ad server or related ad serving system of the present invention to hone in on a user's behavior; it enables the gathering of information on a user's viewing habits and nuances and measuring of how much time a user is viewing a page or a portion of a page, what a user is doing that is different from normal, and other behavioral heuristics.

In the described embodiment, a “general interest” variable index is charted with frequency for each topic. A “general interest” variable of the present invention is calculated by measuring a user's relative amounts of time spent reading content pertaining to a given topic. Without the aid of JavaScript embedded in the ad to track activity in the browser window, as described in the background section, a system is limited to merely the history of impressions for a given user. Embedding JavaScript in an ad and delivering the ad to a browser enables the system to make distinctions between different impressions and thereby make predictions about the user's interest in a topic shown a Web page. Over time it is expected that users will exhibit which topics they are most interested in by how they behave online line with respect to specific viewing actions.

Two user behavior heuristic factors referred to in the described embodiment are blur and focus. For example, a window is in focus if a user is viewing the window. If the user leaves the window, it is no longer in focus; when he comes back, the window is in focus again. Blur, closely related to focus, measures when a window is no longer in focus. For example, blur occurs when a user looking at a Web page switches to reading an e-mail or responding to an instant message. Essentially, the present invention enables the capture of data on what a user is or is not paying attention to. Related to blurring and focus is detecting the maximizing and minimizing of pages. Other heuristics are time-sensitive scrolling on a page, detecting user actions such as scrolling to the bottom of a page, scrolling a few lines then leaving the page, and so on. For example, when a user is viewing a page, it may be determined that the viewer is looking at or reading the middle portion of a page or the bottom of a page. If a user scrolls down a page, the Java Script embedded and delivered with an ad can estimate which viewable portion of a page, also referred to as window in the present invention, a user is looking at. Generally, user actions can be calibrated per user and these actions can be illustrative of a user's interest in the content of a page.

In another embodiment, a user is presented with the opportunity to provide active feedback directly with respect to how relevant an ad is at the time it is shown. This is accomplished by having a small and non-intrusive dynamic form that becomes visible to the user by either clicking on or hovering a mouse pointer over a trigger that resides in a mostly transparent box on top of the ad itself. The form provides fields to specify how relevant the ad is in addition to some fields that would allow the user to specify what types of ads might be effective on the page in question as well as on which types of pages the ad in question may be more effective or be more likely to provoke a user response. An added possibility to the active feedback mechanism is to reward users for providing useful data. The more the user participates, the more she can earn in terms of rewards or any other form of incentive. This active participation by a user can help refine the ad targeting.

The embedded JavaScript method of the present invention transmits reports of captured events relating to a user behavior to the ad server. The transmission mechanism is achieved by creating an Image object in JavaScript and then setting the source target of that image to the event tracking server, which stores and analyzes the events for future targeting. The goal is to not wait too long to transmit reports while not sending them too often, for example, transmitting a report when a single event, such as a single scroll or blur, occurs.

With the present invention, it is helpful to keep in mind that each user is unique. Users have different habits and characteristics when it comes to “surfing the net,”, such as varying reading rates, page volatility, patience thresholds, etc. In the described embodiment, the goal is to hone in on a particular user and determine what the user is doing that is different from the user's typical behavior. For example, has the time spent at a page changed and if so, what is the frequency at which this change happens. Over time, different patterns emerge for each user and an ad server can compare these patterns to see how the user's behavior is changing. The methods of the present invention also involve examining pages or, at a more granular level, examining text to see where a user spends time and extrapolating from this what the user may be interested in. This knowledge will allow an ad server to determine more accurately what types of ads should be delivered to the user.

In another embodiment, the methods described can also be applied to user behavior when viewing images, graphics, or video. For example, the amount of time a user looks at an image or video can be used to determine user interests. Thus, although an image or video is not classified as text is classified, user behavior can be used to deliver targeted contextual ads.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

I claim:

1. A method of determining user interest while a user is viewing content on a computer network, the method comprising:
examining blur associated with a user viewing content on the computer network;
examining focus associated with the user viewing content on the computer network, wherein blur and focus collectively define user viewing behavior;
collecting data on user viewing behavior; and
determining user interest by utilizing the user viewing behavior data.
